(19) United States
(12) Patent Application Publication
(10) Pub. No.: US 2003/0211444 A1
(43) Pub. Date: Nov. 13, 2003

(54) Dental prosthetic structures and components

(76) Inventor: James A. Andrews, Milford, DE (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/385,598

(22) Filed: Mar. 10, 2003

Related U.S. Application Data
(60) Provisional application No. 60/363,213, filed on Mar. 8, 2002.

(51) Int. Cl. A61C 13/12

(52) U.S. Cl. 433/172

(57) ABSTRACT

Dental restorative bridge and denture components are described, such as bars, sleeves and connectors, along with methods for fabricating and placing the restorative bridges and dentures. Bars and sleeves for supporting a denture or bridge are provided, the sleeves retaining a pontic and having channels to embrace bars secured within the mouth. The channels each have a depth exceeding the height of the bar to effectively transfer pontic forces to the dental arch of the edentulous space. Connectors, and the above-mentioned method employing same includes sizing a bar within an edentulous space, releasably attaching one or more connectors to the bar and affixing the connectors to respective abutment copings. The bar is then removed from the connectors, and the copings with affixed connectors are invested and cast. The cast copings are connected to the abutments, one at a time, and the bar is fixedly connected to the connectors.

### RELATED APPLICATIONS

This application claims benefit of U.S. Provisional Application Serial No. 60/363,213, filed Mar. 8, 2002, entitled “ESTHETIC DENTAL PROSTHETHIS”, which is incorporated herein, in its entirety, by this reference.

### FIELD OF THE INVENTION

The invention relates generally to dental prosthetics, such as bridges and partial dentures, and particularly to connectors, bars and sleeves for the support and fabrication of same.

### BACKGROUND OF THE INVENTION

Dental prosthetics, such as bridges and partial dentures, include an artificial tooth or teeth, known as pontics, which extend along a dental arch of an edentulous space, and is either supported on each side of the edentulous space by one or more prepared natural teeth, known as abutment teeth, or by one or more abutment implants secured to bone along the arch of the edentulous space. A variety of connectors, bars, sleeves, posts, pins, etc., are known for securing pontics to abutment teeth or implants.

Providing a patient with a dental bridge or denture by methods known in the art usually is achieved by preparing the abutment teeth and fabricating and placing a unitary bridge casting, including the pontics and appropriate attachments.

Preparation of the abutment teeth often requires extensive surgery, as the teeth must be formed into substantially parallel, pillar-like structures of substantially constant cross-sectional area over a significant height. Casts are then taken of the prepared abutment teeth, cast sockets of a suitable dental metal are prepared therefrom, attachments are incorporated, and the bridge is constructed in a laboratory as a unitary item consisting of the pontics and the integrally cast attachments containing the metal sockets, known as copings, crowns, or caps, which fit accurately over the prepared abutment teeth. The bridge is then placed in the mouth by applying dental cement to the prepared abutment teeth and fitting the copings and attachments of the bridge over the respective abutment teeth.

The unitary nature of the bridge presents difficulties in placement, as single, large castings are susceptible to distortion during fabrication, causing less than optimal alignment of the copings over the abutment teeth or implants. The unitary construction of the bridge also subjects the abutment teeth to considerable bending moments and stresses during pontic use (e.g., occlusal loadings during mastication applied to the abutment teeth or implants), resulting in a breakdown of the abutment teeth or implants, or a detachment of the bridge from the abutments.

Moreover, the surgery required to prepare the abutment teeth is radical, often involving the destruction of considerable quantities of healthy tooth material to accomplish the parallelism required. Also, tissue and bone of the dental arch within the edentulous space underlying the bridge suffers from lack of stimulation, as all forces imparted to the pontics are transferred to the abutment teeth or implant. This possibly results in a receding arch, or a decrease in bone mass, or even an onset of osteoporosis in the un-stimulated bone.

Accordingly, a dental bridge or denture imparting forces of pontic use to the dental arch of the edentulous space, rather than to the abutment teeth or implants, in order to maintain tissue and bone health and to minimize abutment wear and destruction, would impart incredible value to the patient, along with ease and convenience to practitioners and technicians. Further, abutments adapted to only retaining and stabilizing a bridge, rather than to absorbing all operating stresses of the pontics, would afford efficiencies in prosthetic design and placement as abutment preparation would be less drastic, costly, and time consuming. Still further, dental prosthetic structures and components, and a method of fabricating and/or placing same, that avoids large and/or unitary castings, would eliminate the wear and destruction of abutments resulting from distortion associated with fabricating large, unitary castings, and would lessen, considerably, the destruction of healthy tooth material occurring when abutment teeth are prepared, as the necessity for parallel abutment teeth is avoided.

### SUMMARY OF THE INVENTION

The present invention provides bridge and denture components, such as bars, sleeves and connectors, as well as methods for fabricating and placing restorative bridges and dentures. The present invention avoids the need for unitary or large bridge castings, and provides, through the bars and sleeves, a bridge or denture that transmits the forces of pontic use to the dental arch of an edentulous space rather than to the associated abutment teeth or implant. By transferring the functional pontic forces to the dental arch, the present invention provides a bridge or denture that stimulates the tissue and bone of the arch, thereby maintaining tissue and bone health, and minimizing wear to and destruction of the associated abutments. Transmitting pontic forces to the arch also lessens abutment requirements (e.g., fewer abutments, or less substantial or sizable abutments, are required) so that practitioners, using the present invention, can pass resulting affordabilities to the patient.

Connectors of the present invention, and the methods of bridge fabrication and placement, by avoiding a need for unitary bridge castings, eliminates the wear and destruction of abutments resulting from distortions associated with unitary or large castings, and lessens, considerably, a destruction of healthy tooth material when preparing abutment teeth, as the restorations of the present invention do not require that abutment teeth be parallel.

In one aspect of the present invention, a denture support includes a bar to span an edentulous space, the bar having a pair of opposed sidewalls, where the sidewalls define a longitudinal length and a height. The support also includes a sleeve adapted to retain at least one pontic, the sleeve having a channel to embrace the bar, with a depth of the channel exceeding the height of the sidewalls.

In another aspect of the present invention, a denture support includes a pair of spaced-apart bars that span an edentulous space, the bars each having a pair of opposed sidewalls, where the sidewalls each define a longitudinal length and a height. In this aspect, the support also includes a sleeve adapted to retain one or more pontics, the sleeve having a pair of channels adapted to embrace the bars, with each channel having a tract separating two spaced-apart inner faces, the inner faces each defining a longitudinal length and a height, with the inner faces embracing the sidewalls and a height of the inner faces exceeding the height of the sidewalls.

In another aspect of the present invention, a dental bridge includes a bar spanning an edentulous space with at least one portion of the bar secured to a corresponding abutment. The bar has a pair of opposed sidewalls, with the sidewalls defining a longitudinal length and a height. The bridge also includes a sleeve adapted about its exterior to retain at least one pontic, and having a channel adapted to embrace the bar, where the channel has a depth exceeding the height of the sidewalls.

In another aspect of the present invention, a dental bridge includes a curvilinear bar spanning an edentulous space, with each end of the bar secured to a corresponding abutment. The bar has a pair of opposed sidewalls, the sidewalls defining a longitudinal length and a height. In this aspect, the bridge also includes a curvilinear sleeve adapted to embrace the bar and to retain at least one pontic, the sleeve being U-shaped in transverse cross-section, the sleeve having a bight and two spaced-apart legs, the legs each having an inner and an outer face, the inner and the outer faces each defining a longitudinal length and a height, where the inner faces embrace the sidewalls and the height of the inner faces exceeds the height of the sidewalls.

In another aspect of the present invention, a dental bridge includes a pair of spaced-apart bars spanning an edentulous space with at least one portion of each bar secured to a corresponding abutment. The bars each have a pair of opposed sidewalls, the sidewalls each defining a longitudinal length and a height. The bridge also includes a sleeve adapted to retain one or more pontics and having a pair of channels adapted to embrace the bars, where a depth of each channel exceeds the height of the sidewalls.

In another aspect of the present invention, a dental bridge includes a pair of parallel, spaced-apart, curvilinear bars spanning an edentulous space, each end of the bars secured to a corresponding abutment, the bars each having a pair of opposed sidewalls, with the sidewalls each defining a longitudinal length and a height. In this aspect, the bridge also includes a curvilinear sleeve adapted to retain one or more pontics, the sleeve having a pair of channels adapted to embrace the bars, each channel being U-shaped in transverse cross-section and having a tract separating two spaced-apart inner faces, the inner faces each defining a longitudinal length and a height, where the inner faces embrace the sidewalls and the height of the inner faces exceeds the height of the sidewalls.

In another aspect of the present invention, a method for fabricating a dental restorative bridge or denture includes positioning a bar across an edentulous space that spans one or more abutments, then sizing the bar to fit the space. One or more connectors are then releasably attached to the bar and the bar is re-positioned across the edentulous space to affix the connectors to respective copings of the abutments. After affixing the connectors to the copings, the bar is removed from the one or more connectors and the copings and respectively affixed connectors are invested and cast. Finally, the bar is fixedly connected to the one or more connectors so that the bar can accept and retain a pontic portion of the bridge or denture.

In another aspect of the present invention, a method for fabricating and placing a dental restorative bridge or denture includes positioning a bar between two abutment teeth at opposite ends of an edentulous space, then sizing the bar to fit the space. A connector is releasably attached to each end of the bar, the connectors each including an open side for later removal of the bar. The bar is then re-positioned across the edentulous space to affix the connectors to respective copings of the abutment teeth, the bar then being removed from the one or more connectors. The copings and the respectively affixed connectors are then invested and cast. Finally, each cast coping with respectively cast connector is fixedly connected to a respective abutment tooth, one at a time using a suitable dental cement, then each end of the bar is fixedly connected to a respective connector by suitable dental cement. The bar can then accept and retain a pontic portion of the bridge or denture. The methods of the present invention can each further comprise, prior to placement of the bridge or denture, preparing abutment teeth for reception of the copings, wherein the prepared abutment teeth are non-parallel when prepared.

In another aspect of the present invention, a dental prosthetic connector for attaching a bridge or denture to an abutment coping includes two ends and four sides, where at least one end and one of the three sides are open, with the three other sides being closed. The connector enables a receiving of and a releasable retaining of a bridge or denture supporting bar, rod, or post, the connector being flexible in a pre-casting method of fabricating a bridge or denture that further enables a post-casting placement of the bridge or denture in the mouth where cast abutment copings are individually fixedly connected to respective abutments and the supporting bar, rod, or post is fixedly connected to the connectors. The bar, rod, or post then accepts and retains a pontic portion of the bridge or denture.

In another aspect of the present invention, a dental prosthetic connector for attaching a bridge or denture to an abutment coping is contemplated, where the connector is used in a method of fabricating and placing a dental restorative bridge or denture as heretofore described. The connector can be used in a method involving one or more abutment teeth or implants.

### BRIEF DESCRIPTION OF THE DRAWINGS

For the purpose of illustrating the invention, there is shown in the drawings forms presently preferred; it being understood, however, that the present invention is not limited to the precise arrangements and instrumentalities shown:

FIG. 1 illustrates a bottom plan view of an upper dental arch showing a single bar embodiment of the present invention spanning an edentulous space between supporting abutment teeth;

FIG. 2 illustrates a rear perspective view, in partial section, of a bridge incorporating a sleeve of the present invention;

FIG. 3a illustrates a fragmentary, exploded perspective view showing the bar and the sleeve of FIGS. 1 and 2, respectively;

FIG. 3b illustrates the bar and the sleeve shown in FIG. 3a, with the sleeve positioned to receive the bar, FIG. 3b showing a depth of a channel of the sleeve exceeding a height of the bar, in accordance with one aspect of the present invention;

FIG. 4 illustrates a substantially central, cross-sectional view of the upper dental arch of FIG. 1 with the bridge of FIG. 2 in place, the bridge retained against the arch through engagement of the bar and the sleeve;

FIG. 5 illustrates a bottom plan view of an upper dental arch showing a double bar embodiment of the present invention spanning an edentulous space along with a bridge retained by the double bar;

FIG. 6a illustrates a fragmentary, exploded view perspective view showing the double bar of FIG. 5 and a sleeve having two channels to engage the double bar, in accordance with another aspect of the present invention;

FIG. 6b illustrates the double bar and the two-channel sleeve shown in FIG. 6a, with the sleeve positioned to receive the double bar, FIG. 6b showing a depth of the channels exceeding a height of each of the double bars;

FIG. 7 illustrates a substantially central, cross-sectional view of the upper dental arch and bridge of FIG. 5, the bridge retained against the arch through engagement of the double bar and the two-channel sleeve;

FIG. 8 illustrates a side elevation view of an upper dental arch showing a further aspect of the present invention, where a double bar embodiment is supported with one abutment;

FIG. 9 illustrates a fragmentary, bottom plan view of the upper dental arch of FIG. 8;

FIG. 10 illustrates a perspective view of a bridge adapted to be retained by the double bar, single abutment embodiment of the invention shown in FIGS. 8 and 9;

FIG. 11 illustrates a bottom plan view of an upper dental arch showing a single bar embodiment of the present invention spanning an edentulous space and supported by implant abutments;

FIG. 12a illustrates a cross-sectional view of a bridge retained to a lower dental arch by a single bar and sleeve embodiment of the present invention, FIG. 12 showing that an inward force on a pontic of the bridge is transmitted to a lingual ridge of the lower dental arch, in accordance with one aspect of the present invention;

FIG. 12b illustrates a cross-sectional view of a bridge retained to a lower dental arch by a single bar and sleeve embodiment of the present invention, FIG. 12 showing that an outward force on a pontic of the bridge is transmitted to a buccal ridge of the lower dental arch, in accordance with one aspect of the present invention;

FIG. 13 illustrates a cross-sectional view of a bridge retained to a lower dental arch by a single bar and sleeve embodiment of the present invention, with the bar buccally positioned relative to the ridge of the arch, FIG. 12 showing that forces applied to a biting surface of a pontic of the bridge, in any direction (e.g., occlusal loading) are nonetheless transmitted to the lingual and/or buccal ridge of the lower dental arch, in accordance with one aspect of the present invention;

FIG. 14a illustrates a perspective view of two connectors, in accordance with another aspect of the present invention, the connectors releasably connected to respective ends of a single bar;

FIG. 14b illustrates a perspective view of one of the connectors of FIG. 14a, showing a channel of the connector adapted to receive the bar;

FIG. 15a illustrates a perspective view of a lower dental arch showing the connectors of FIG. 14a retaining a single bar relative to abutment teeth spanning an edentulous space in accordance with a method of the present invention for fabricating a dental restorative bridge or denture;

FIG. 15b illustrates a partial perspective view of the bar of FIG. 15a being removed from a connector of FIG. 14b subsequent to fixation of the connector to an abutment coping in accordance with the method of the present invention for fabricating a dental restorative bridge or denture;

FIG. 16a illustrates a perspective view of an upper dental arch having an edentulous space between two, outwardly projecting, non-parallel abutment teeth;

FIG. 16b illustrates a perspective view of the upper dental arch and the edentulous space of FIG. 16a, showing two prepared and non-parallel abutment teeth, two cast abutment copings, each having a fixedly attached cast connector, and a bar, in accordance with a method of the present invention for placing a dental prosthesis;

FIG. 17 illustrates a perspective view of a lower dental arch having an edentulous space within which two non-parallel implant abutments each support a connector of the present invention, the connectors adapted for securing a single bar embodiment of the present invention, FIG. 17 illustrating an alternative application of the method of the present invention for placing a dental prosthesis; and

FIG. 18 illustrates a perspective view of a lower dental arch having an edentulous space housing an exemplary implant embodiment placed in accordance with the method of the present invention for placing a dental prosthesis.

### DETAILED DESCRIPTION OF THE INVENTION

The present invention includes restorative dental prosthetic structures and components, such as bars, sleeves and connectors, as well as methods for fabricating and placing the restorative structures and components. The various aspects of the present invention (methods and apparatus) are described herein individually, and as a system or assembly. The present invention contemplates that each aspect, or set of aspects, can be used with other dental structures, components, or methods not described herein, as would be applicable and logical in the art.

A single bar embodiment of the invention

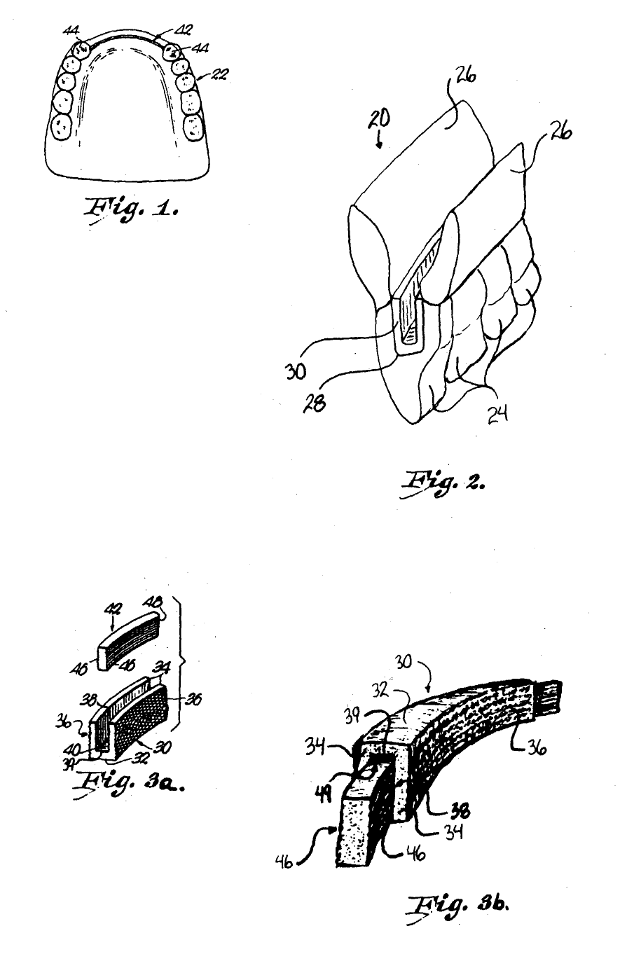

FIGS. 1-4 illustrate a single bar embodiment of the present invention, where a dental bridge 20 is designed for placement into a dental arch 22. Although FIG. 1 illustrates an upper arch 22, where the bridge 20 includes pontics 24 of central and lateral incisors, it is understood that that any one or more pontics may be included in the bridge, within contemplation of the present invention, and the arch 22 could be upper or lower.

The bridge 20, as particularly illustrated in partial section in FIG. 2, includes four pontics 24 and an artificial tissue portion 26 (e.g., acrylic simulated tissue) molded in surrounding relationship to an upper portion of the pontics 24 so that the bridge 20, when inserted into the arch 22 in a manner hereinafter described, is complementary to the arch 22, residing thereupon, and presents a realistic appearance. In order that the bridge 20 may be removably inserted into the arch 22, the pontics 24 of the bridge 20 have a slot 28 in a rear face thereof, the slot 28 adapted to receive a longitudinally curvilinear sleeve 30, the sleeve 30 being seated within the slot 28 and suitably secured therein by adhesive or the like. An outer surface of the sleeve 30 may be provided with knurling to thereby enhance the fit of, and aid in securing, the sleeve 30 into the slot 28.

The sleeve 30 of this embodiment is U-shaped in transverse cross-section, thereby presenting a bight 32 and a pair of spaced-apart, normally vertically disposed legs 34. The legs 34 each present an outer face 36, which can be knurled as mentioned above, and an inner face 38. The inner and the outer faces 38, 36 each define a surface having a longitudinal length and a width (or height). A tract 39 separates the inner faces 38, the inner faces 38 and the tract 39 defining a U-shaped channel or groove 40. Accordingly, the tract 39 defines a width of the channel 40.

In order to receive the bridge 20, the arch 22 is provided with a longitudinally curvilinear bar 42 to span an edentulous space. The bar 42 is substantially rectangular in transverse cross-section, and in this embodiment spans the edentulous space a distance between a pair of spaced-apart abutment teeth 44, the bar 42 being suitably secured to the abutment teeth 44 by fusing each end of the bar 42 to a respective abutment tooth 44 in a manner known in the art. In certain aspects and/or uses of the present invention, it may only be necessary to secure one end of the bar, and/or the bar may be secured at a location other than its end, in one or more locations along the bar, and/or the bar may be secured to something other than an abutment tooth, such as an implant.

The bar 42, being rectangular in cross-section, presents a pair of opposed, parallel sidewalls 46. Each sidewall 46 defines a surface having a longitudinal length and a width (or height). Each sidewall 46 embraces a respective inner face 38 of a leg 34 of the sleeve 30 to secure the bridge 20 against the arch 22.

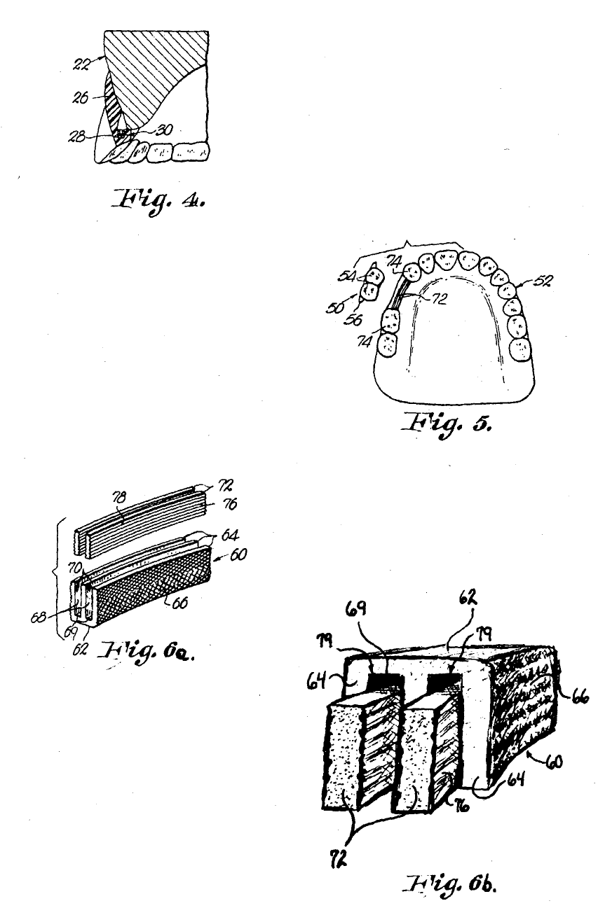

Referring now to FIGS. 3a and 3b, each inner face 38 of the sleeve 30 has a height exceeding a height of a respective sidewall 46. In other words, a depth of the channel 40 is greater than the height of the sidewalls 46 of the bar 42. Accordingly, the channel 40 can cover, or receive, the entire bar 42 while still creating a space or void 49, within the channel 40. This feature, or characteristic, of the present invention (i.e., having a channel 40 deeper than a sidewall 46 height) enables forces imposed on the pontics during use to be transferred to the dental arch 22, as discussed infra.

The sidewalls 46 could include a plurality of minute serrations 48 formed thereupon, preferably longitudinally extending, to provide a corrugated surface about the length and width, or height, of the sidewalls 46. Although shown as smooth in FIGS. 1-4, the inner face 38 of each leg 36 of the sleeve 30 could also be provided with serrations, preferably longitudinally extending, to complementally mate with the serrations 48 on the sidewalls 46 of the bar 42, thereby enhancing a retention of the sleeve 30 over the bar 42 when the sleeve 30 and the bar 42 are engaged in a embracing relationship.

The bar 42 and the sleeve 30 are made of materials suitable in the art for the purpose, but might preferably be constructed of a high-strength, corrosion resistant metal having properties providing sufficient cohesive force between the sidewalls 46 of the bar 42 and the inner face 38 of the sleeve 30, thereby not requiring the inner faces 38 of the sleeve 30 to include serrations. Perhaps more preferably, the metal might be in the form of an austenitic chrome alloy or titanium alloy metal having the property of developing a sufficient cohesive force between inter-engaged faces thereof to prevent easy displacement of components, such as the bar 42 and the sleeve 30, from one another. Thus, when the bar 42 and the sleeve 30 are fabricated from such a metal, a positioning of the sleeve 30 into an embracing relationship with the bar 42 will cause surface molecules to align themselves in such fashion that a strong cohesive force is created. When such a metal is used, the serrations 48 permit only a random surface contact to occur between the sidewalls 46 and the inner face 38, thereby facilitating subsequent removal of the sleeve 30 from the bar 42. Thus, random surface contact between the bar 42 and the sleeve 30, in view of the nature of the metal from which each is fabricated, is sufficient to retain the sleeve 30 on the bar 42 and to resist relative movement therebetween without preventing such movement when it is desired to separate the sleeve 30 from the bar 42, as by applying an adequate force to the sleeve 30.

On the other hand, if metals not having the above described properties are used for the bar 42 and the sleeve 30, the serrations 48 enable retention between components to be increased, inasmuch as the serrations 48 on the sidewalls 46 would tend to bite into or grip the inner face 38 of the sleeve 30, it also being noted that the inner face 38 might optionally be provided with complementary serrations to yet further increase retention between the components.

The bar 42 and the sleeve 30 could each be straight, but when appropriate might each be longitudinally curvilinear in configuration. The longitudinally curvilinear configuration might be in the form of an arc of a common circle, whereby the bar and the sleeve are of identical longitudinal configuration. An identical longitudinal configuration of the bar and the sleeve not only permits interchangeability of a user's bridge, should the sleeve and pontic portion be lost or damaged, but is also important in satisfactorily retaining the sleeve embracing relationship to the bar. Thus, a curvilinear configuration of components permits a greater retention therebetween and further permits the frictional fit to be regulated or adjusted by minutely distorting the bar to reestablish random surface contact between the bar and the sleeve. Such distortion is possible only if components are curvilinear, inasmuch as if the components were straight, any distortion of the bar would tend to shorten the length thereof, thereby creating pressure on the abutment teeth.

Thus, a combination of a bar and a sleeve each having an arc of a common circle, and fabricated from a metal such as hereinabove described, creates a dental bridge wherein the sleeve may be tightly retained in frictional embracing relationship with the bar, but yet which may be easily removed upon application of necessary force thereto, the arcuate configuration of the components adding to the strength of retention therebetween and yet further permitting adjustment of the bridge for continued retention should continued use thereof alter or weaken the original retention characteristics.

A double bar embodiment of the invention

FIGS. 5-7 illustrate a double bar embodiment of the present invention, where a dental bridge 50 is designed for placement into an arch 52. Although FIG. 5 illustrates an upper arch 52, where the bridge 50 includes pontics 54 of first and second premolars, it is understood that that any one or more pontics may be included in bridge, within contemplation of the present invention, and the arch 52 could be upper or lower.

The bridge 50, as illustrated in FIGS. 5-7, includes two pontics 54 and an artificial tissue portion 56 molded in surrounding relationship to an upper portion of the pontics 54 so that the bridge 50, when inserted into the arch 52, is complementary to the arch 52 and presents a realistic appearance. In order that the bridge 50 may be removably inserted into the arch 52, the pontics 54 of the bridge 50 have a slot 58 in a rear face thereof, the slot 58 adapted to receive a longitudinally curvilinear sleeve 60, the sleeve 60 being seated within the slot 58 and suitably secured therein by adhesive or the like. An outer surface of the sleeve 60 may be provided with knurling to thereby enhance the fit of, and aid in securing, the sleeve 60 within the slot 58.

The sleeve 60 of this embodiment is W-shaped in transverse cross-section, thereby presenting a bight 62 and three spaced-apart, normally vertically disposed legs 64. The two outer legs 64 (of the three) each present an outer face 66, which can be knurled, and an inner face 68. The one center leg 64 (of the three) presents two inner faces 68. The inner and the outer faces 68, 66 each define a surface having a longitudinal length and a width (or height). A tract 69 separates the inner faces 68 of adjoining legs 64, where a pair of inner faces 68 and a respective separating tract 69 each define a U-shaped channel or groove 70. Accordingly, the tract 69 defines a width (or thickness) of the respective channel 70, and the sleeve 60 includes two parallel channels 70. As discussed in the foregoing embodiment, the inner faces 68 are smooth, as illustrated, although it will be appreciated that the inner faces 68 could be provided with suitable serrations or the like.

In order to receive the bridge 50, the arch 52 is provided with a pair of spaced-apart, parallel, longitudinally curvilinear bars 72 to span an edentulous space. The bars 72 are substantially rectangular in transverse cross-section, and in this embodiment span the edentulous space a distance between a pair of spaced-apart abutment teeth 74, the bars 72 being suitably secured to the abutment teeth 74 by fusing each end of the bars 72 to a respective abutment tooth 74 in a manner known in the art. In certain aspects and/or uses of the present invention, it may only be necessary to secure one end of the bar, and/or the bar may be secured at a location other than its end, in one or more locations along the bar, and/or the bar may be secured to something other than an abutment tooth, such as an implant.

The bars 72, each rectangular in cross-section, each present a pair of opposed sidewalls 76. Each sidewall 76 defines a surface having a longitudinal length and a width (or height). Each sidewall 76 embraces a respective inner face 68 of a leg 64 of the sleeve 60 to secure the bridge 50 against the arch 52. The sidewalls 76 could include a plurality of serrations 78 formed thereupon, preferably longitudinally extending, to provide a corrugated surface about the length and width, or height, of the sidewalls 76.

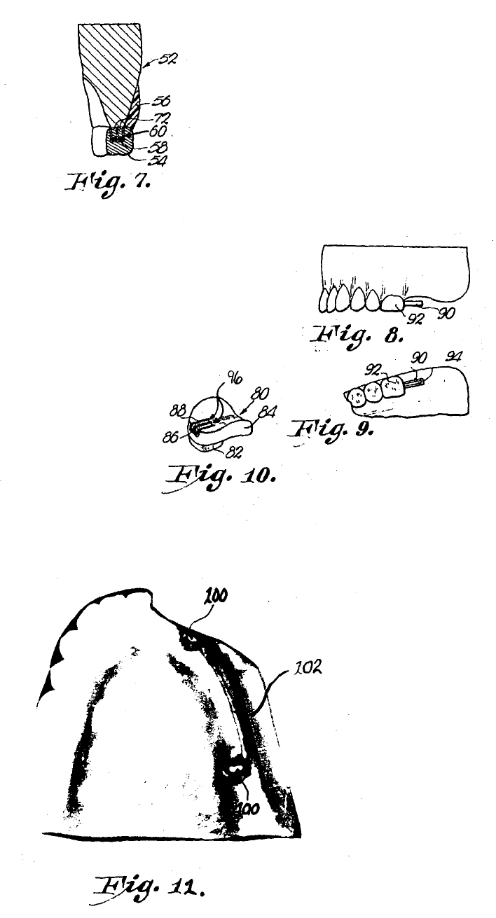

Referring now to FIGS. 6a and 6b, each inner face 68 of the sleeve 60 has a height exceeding a height of a respective sidewall 76. In other words, a depth of each channel 70 is greater than the height of the sidewalls 76 of the bars 72. Accordingly, a channel 70 can cover, or receive, an entire bar 72 while still creating a space or void 79, within the channel 70. This feature, or characteristic, of the present invention (i.e., having a channel 70 deeper than a height of a sidewall 76) enables forces imposed on the pontics during use to be transferred to the dental arch 52, as discussed infra.

In this embodiment, the sleeve 60 and the bars 72 could also each be fabricated of a high-strength, corrosion resistant metal having a property of providing sufficient cohesive force between interrogated surfaces of the sleeve 60 and the bars 72, thereby substantially resisting relative movement of the sleeve 60 relative to the bars 72, such retention being enhanced by the properties of the metal, but yet where removal of the sleeve 60 from the bar 72 is aided by provision of the serrations 78 on the bars 72 when an adequate force is applied to the sleeve 60. The sleeve 60 and the bars 72 could also each be curvilinear in longitudinal configuration, each constituting an arc of a common circle for purposes hereinabove explained.

A single abutment embodiment of the invention

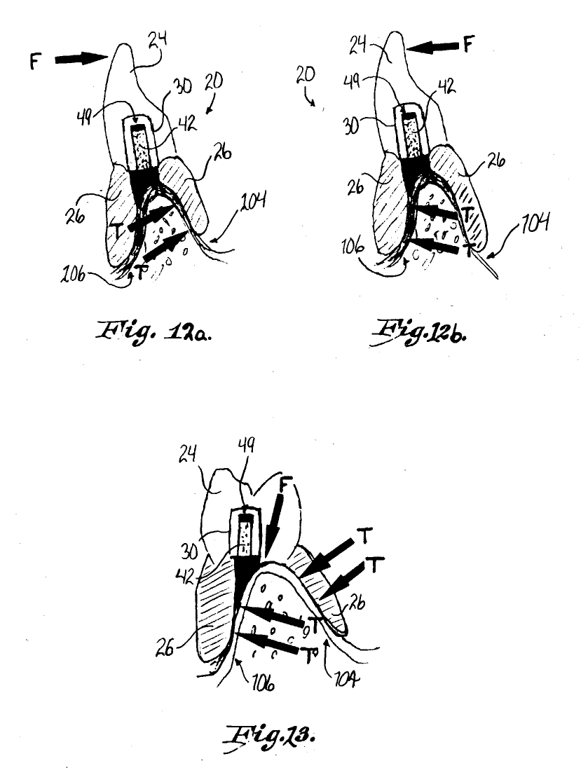

FIGS. 8-10 illustrate a single abutment embodiment of the present invention, where a single-tooth saddle bridge 80 includes a pontic 82 and a tissue portion 84, the tissue portion 84 having a slot 86 formed therein for receiving a W-shaped sleeve 88.

A pair of bars 90 is suitably attached to a posterior abutment tooth 92 in any suitable manner to cantilever the bars 90 from the abutment tooth 92. The bars 90 are similar in construction to the previously disclosed bars 42, 72, i.e., each being rectangular in transverse cross-section, and each presenting a pair of opposed sidewalls defining a longitudinal length and width (or height). However, since the bars 90 of this embodiment are attached to only a single abutment tooth 92, free ends of the bars 90 are interconnected by a stretch 94 to maintain parallelism.

The sleeve 88, W-shaped in transverse cross-section, is similar in configuration to the sleeve 60 disclosed above for the double bar embodiment. Particularly, the sleeve 88 defines two U-shaped channels 96, each of which includes a depth exceeding a height of sidewalls (not numbered) of the bars 90. Accordingly, each channel 96 can cover, or receive, an entire respective bar 90 while leaving a space or void within the channel 96.

The bars 90 and the sleeve 88 of this embodiment could be straight, or could be longitudinally curvilinear in configuration, constituting an arc of a common circle. In this posterior embodiment, the curvilinear configuration would constitute an arc of a circle having greater circumference than those previously disclosed, so great that the bars 90 would be substantially straight, although yet still constituting an arc of a circle. Likewise, the sleeve 88 and the bars 90 of this embodiment could be fabricated from materials previously described.

Characteristics and aspects of sleeve channels deeper than bar height

Certain embodiments of the present invention include channels 40, 70, 96, each having a depth exceeding a height, or width, of a respective bar 42, 72, 90. Accordingly, each channel 40, 70, 96 can cover, or receive, an entire respective bar 42, 72, 90 while leaving a space or void within the channel 40, 70, 96.

Having a bar height exceeded by inner faces of a respective sleeve ensures, at all times, full bar sidewall to sleeve contact, thereby providing maximum retentive capacity. Further, the space or void existing within the channel allows translational movement of the sleeve relative to the bar during use. This flexibility in positioning enables the acrylic simulated tissue of the bridge to become fully seated on a patient's natural ridge tissue of the dental arch without interference by a sleeve that “bottoms out”, or becomes restrictively engaged, with a bar (i.e., a tract of a channel abuts an adjacent edge of a bar before the artificial tissue of the bridge fully seats against the patient's ridge tissue).

Ensuring full bar to sleeve contact, and ensuring proper seating of artificial tissue to a patient's natural ridge (thereby enabling full and solid ridge support), provides an immobile, ridge-borne pontic section, where the patient's natural ridge aids in intercepting and absorbing functional forces exerted on the pontics, thereby relieving stresses normally imparted to the abutments. Accordingly, the present invention contemplates abutments and bars adapted to only retain and stabilize ridge-borne pontics, where the ridge-borne pontic section transfers functional stresses to the patient's ridge, as enabled by channels having a depth exceeding bar height.

A transfer of functional stresses to the patient's ridge enables a less complicated abutment design to sufficiently support a respective bridge or denture than would be required when the abutment must absorb the functional stresses imparted to the pontics. Accordingly, the present invention requires fewer and/or lesser (i.e., less extensive) abutments, whether tooth or implant, than alternative dental prosthetics, the present invention thereby expanding access to optimal dental care to those previously precluded from same due to extensive abutment preparation necessities and/or affordabilities.

For example, the present invention allows natural teeth, or a single natural tooth, to provide abutment support when the natural tooth may not otherwise sufficiently do so, or might be damaged in doing so. Functional forces exerted by the pontics on the abutments, which remain non-excessive due to aspects of the present invention, can actually stimulate and strengthen the natural abutment teeth employed.

For implants, where attachment is by “osseous-integration,” excessive sheering, functional forces can minutely rupture the integration. Reparative response to the rupturing is limited, and such forces, when excessive and repeated, frequently lead to loss of the implant. Accordingly, the value of the capacity to make dental restorations ridge-borne, where the implant is required to only retain and stabilize the bridge, and not absorb operable stresses, provides measurable and objective benefits to patients, practitioners, and technicians.

For example, FIG. 11 illustrates an application of the present invention where two implants 100 support a bar 102 used to restore one-half of a ridge with a bridge possessing seven pontic teeth. Without the ridge-borne feature, at least three other implants would be necessary. Gaining bone to house the additional implants could require thousands of dollars, and double or triple the cost of the entire restoration.

Further, the curvilinear configuration of the bars and sleeves, and its frictionally fitting influence between the bars and sleeves, together with the ridge-borne absorption of functional stresses, provide an immobile, functionally fixed dental restoration even though the bridge remains translationally movable relative to the bar. The curvilinear configuration denies a capacity to lift or depress one end of the sleeve without a balanced force that lifts or depresses the entire segment, or span, simultaneously. For instance, a lifting or depressing force at just one end becomes a frictionally binding force over other portions of the bridge. This ensures that all forces imposed on the pontic are transferred to the underlying, supporting bony ridge of the patient.

Transferring functional stresses on the pontics to the underlying bony ridge of the patient's dental arch maintains, and even restores, the patient's underlying ridge by providing continuous stimulation to the ridge. Natural ridge tissue and bone, like tissue and bone elsewhere in the body, requires stimulation and use to avoid decay. Without stimulation, ridge bone becomes victim to osteoporosis, as calcium will cease to deposit. Accordingly, bone will be lost due to lack of use. Therefore, through use of the present invention, patient's can maintain ridge tissue and bone health, almost as if natural teeth are in place, when in reality a denture spans the edentulous space.

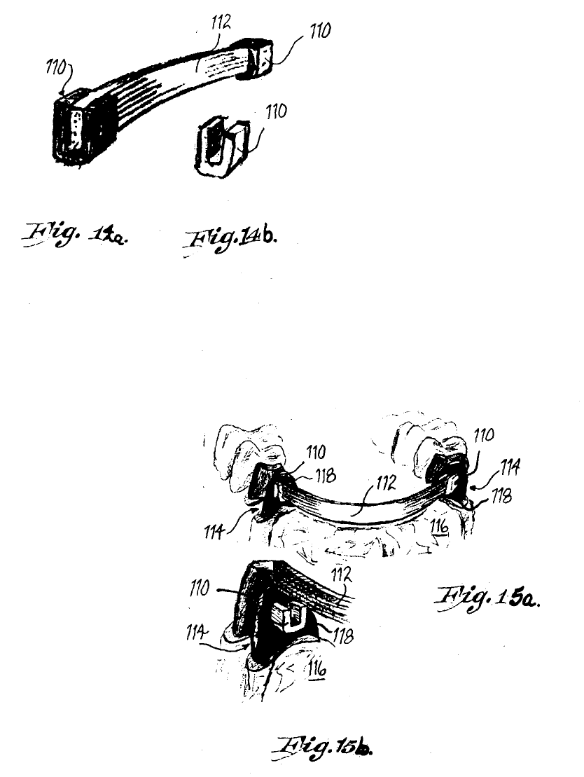

FIGS. 12a and 12b illustrate, in cross-section, how single bar-retained, ridge-borne restorations of the present invention deflect, or transfer, functional forces imparted on the pontics to residual ridges of the patient. In FIG. 12a, an inward force directed to the pontic 24 tip, in a direction shown by arrow “F”, imparts or transmits the force, as shown by arrow “T”, to the entire lingual of the ridge 102 by the artificial tissue portion 26 of the bridge 20. In FIG. 11b, an outward force directed to the pontic 24 tip, in a direction shown by arrow “F”, imparts or transmits the force, as shown by arrow “T”, through the artificial tissue portion 26 of the bridge 20 to the entire buccal of the ridge 104.

The transmission of the forces to the ridges occurs regardless of the exact positioning of the bar relative to the ridge. Referring now to FIG. 13, where an exemplary embodiment in cross section shows the bar buccally located relative to ridge, it can be appreciated that forces in any direction applied to the biting surface of the pontics are directed to the ridge, thereby sparing the implants or abutment teeth forces normally absorbed by abutments of conventional bridgework.

A connector, or mating unit, embodiment of the invention and a method for fabricating and placing a dental prosthesis

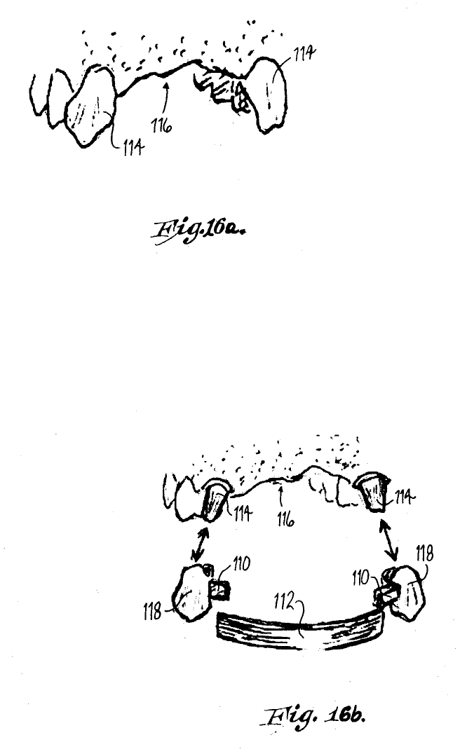

Referring now to FIGS. 14a and 14b, a connector 110, or mating unit, is presented for and is part of a method for fabricating and placing a restorative dental prosthesis. The prosthesis can be connected to abutment teeth at opposite ends of an edentulous space or to abutment implants about the space. In one aspect of the present invention, the connector 110 includes two ends and four sides, where at least one end and one of the three sides is open, and the three other sides are closed, the connector thereby enabling a receiving of and a releasable retaining of a bridge or denture supporting bar, rod, or post.

In another aspect of the present invention, the connector 110 can, essentially, resemble a two to three millimeter segment of the sleeve 30 of the present invention, the connector 110 being plastic and having a U-shaped cross-section. The connector 110 would accordingly be adapted to snuggly embrace a prosthetic supporting bar 112, as shown in FIG. 14a. In this aspect, the supporting bar 112 could be the bar 42 of the present invention. However, the connector 110 could vary in shape, and cross-section, depending on a shape and contour of the prosthetic supporting bar, or supporting mechanism employed, as long as the connector 110 allows insertion and removal of the prosthetic supporting mechanism during positioning, sizing, and fastening, as discussed infra. As shown in FIG. 14b, at least in one aspect, the connector 110 is U-shaped in an elevation or cross-sectional view, and has smooth bottoms and sides. However, there may be application for knurling and/or markings on the exterior of the connector 110.

In a method of fabricating and placing a dental restorative prosthesis and incorporating the connector 110, a prosthetic supporting bar 112 is first cut to fit between and against two abutment teeth 114, the abutment teeth including thereon, at this stage, wax or plastic abutment caps, crowns, or copings 118. The connectors 110 are then placed on the bar 112 ends, with open end up, the connectors frictionally embracing the bar due to having a channel width adapted to the bar 112 thickness, as shown in FIG. 14a. The bar 112 is then again placed within the mouth, in a desired position along or about an arch 116 of the edentulous space, the connectors 110 being placed against the wax or plastic copings 118 of the abutments 114. The connectors 110 are affixed to the copings 118 by a wax or plastic joint. The bar 112 is then lifted away from the connectors 110, as shown in FIG. 15b, allowing the copings 118 with respectively affixed connectors to be invested and cast in a desired material, such as a precious or non-precious metal. A practitioner may invest and cast the components, or may direct the casting to a laboratory.

After the abutment copings 118 are cast, the cast copings 118 are seated on the abutment dies of the master cast. The bar 112 is inserted into the now “metalized” connectors 110. A sleeve to retain pontics of a bridge, such the sleeve 30 of the present invention, can now be sized and cut to the bar 112 and a pontic section for the restoration, such as the pontics 24 of the present invention, can be fabricated.

After casting the abutment coping 118 restoration, which includes properly positioned and metalized connectors 110, the bar 112 can be cemented to the connectors 110 on the master cast, or in the mouth during placement. Any bonding cement suitable for the purpose and enabling a durable, stable fixation of the bar 112 to the metalized connectors 110 can be employed, such as Meta-bond®, Panavia®, and Geristore®.

This option in the method of adhesion (i.e., the choice of cementing the bar 112 to the connectors 110 in the laboratory or in the mouth during placement) provides the practitioner great flexibility and ease of prosthetic placement, especially when the abutments 114 are not parallel.

If the abutments 114 are parallel, or if the abutments can be screwed (i.e., mechanically fastened) into or onto implants in a precise manner, it may be fortuitous to laser-weld the bar 112 to the connectors 114 in the dental laboratory while the abutment copings are seated on the master cast, thereby creating a unitary unit and placing the restoration accordingly. If the abutments 114 are not parallel, or if final bar 112 position relative to necessary restoration attachments during placement, would hamper the placement within the mouth, it may be fortuitous to fasten the bar 112 to the connectors 110 in the mouth (e.g., after individual placement of one or implants, or individual adhesion of copings to abutment teeth).

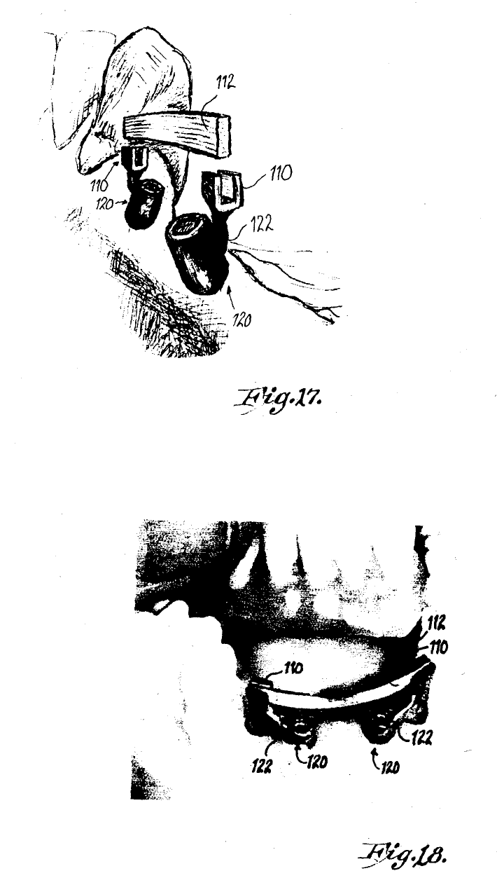

For example, referring now to FIGS. 16a and 16b, when potential abutment teeth 114, at opposite ends of an edentulous space, angle outward or are out of parallel, special concerns and considerations face the practitioner. For abutment teeth to receive a unitary restoration, or unitary restoration support, including abutment crowns joined in the laboratory by a pontic support bar or rod, the abutment teeth 114 must be prepared in parallel. When the abutment teeth 144 diverge, as shown in FIG. 16a, preparation requires extensive tooth reduction.

The present invention, enabling individual and separate casting and placement of abutment copings, with affixed connectors, and a spanning bar connection occurring in the mouth, allows abutments to be out of parallel. Accordingly, use of the connectors 110, and the method described above, enables the abutment teeth 114 to be prepared normally, with only normal cosmetic preparation, without reference to, or a need for, making the abutment teeth 114 parallel to one another, thereby avoiding a need for unusual or extensive tooth reduction. The abutment teeth 114, in these cases, are joined by cementing the bar 112 into the connectors 110 after the abutment crowns 118 are cemented, one at a time, to the abutment teeth 114 in the mouth.

Further, for crowns to look natural at the gum line, it is important that there be no dark show of metal. This can be avoided by creating a one-millimeter deep shoulder on the lip-cheek face of the abutment tooth when preparing same for abutment crowns, as shown in FIG. 16b, which also assists in minimizing an amount of healthy tooth material removed from the abutment teeth 114.

The convenience and value of the connector 110, and the method of using same, expands when multiple abutments are employed on each side of the edentulous space. Abutments need only be parallel with those on the same side of the edentulous space. Further, having the capability to cement each side of the edentulous space separately provides great convenience and advantage during placement, as it eliminates difficulties associated with keeping both sides of the edentulous space dry simultaneously, and avoids the problems resulting from a failure to do so. For instance, the steps of cementing restoration components, and then removing the excess cement, can be performed one side at a time with the present invention. This eliminates a common temptation, when cementing both sides simultaneously (e.g., when placing a unitary prosthesis), of removing excess cement from one side a bit early in order to move swiftly to the other side, and remove the excess cement, before the excess becomes hard and must be chiseled off.

Referring now to FIG. 17, the present invention also enables implant abutments 120 aligned completely out of parallel to have associated abutment copings 122, each with a connector 122, cemented individually, then joined by cementing the bar 112 into the connectors 110 aligned to receive the bar 112. Having the capability to cement implant abutment copings 122 allows practitioners, especially implant novices, the comfort and ease of placing implant restorations in a manner to which they are familiar, i.e., in a manner similar to placement of restorations on natural tooth abutments.

Accordingly, joining the abutment implants 120 by cementing the bar 112 to the connectors 110, in the mouth, after the copings 122 are individually placed, eliminates any potential for torque damage to implants due to screwing in joined and imperfectly related abutments as part of a unitary prosthesis. Large and unitary castings are susceptible to distortion. If distorted abutments of a unitary or large casting, even if distorted only a slight degree, are screwed into the mouth, the mechanical advantage of the screws can leverage the implants, causing rupture of integration between implant and bone, and can cause a loss of the implant or implants.

Use of the connectors 112, and/or the method of restoration fabrication and placement of the present invention, eliminates the need for large and/or unitary castings, along with the inherent shortcomings and risk of failure associated therewith, such as:

distortion of coping relations that may occur during handling of the wax or plastic abutments in the investing process

unavoidable distortion of large castings due to expansion and contraction of investing stones during setting, and thermal changes occurring during casting

cumulative distortion effecting terminal ends of longer castings due to the successive processes that components of longer castings are subjected, which are avoided by casting coping units separately

a disruption of osseous integration of the implant, with likely implant loss, if slightly misaligned abutments are screwed in, this due to the mechanical advantage of the screw and the resulting torque imposed on an implant

The present invention enables single copings to be placed in the mouth individually, one at a time, and then the bar 112 cemented into the connectors 110 to join abutments spanning an edentulous space, thereby guarantying a passive fit. By way of example, FIG. 18 illustrates an embodiment where implant abutments 120 were placed by screw, with the bar 112 cemented into the connectors 110 in the mouth. In this embodiment, the present invention provides for passive placement of splinted abutments on each side of the edentulous space, and the connectors 110 enable the bar 112 to be finally located to enable simulated teeth and tissues to recreate normal anatomic contours, thereby providing optimal esthetics and subjective comfort. Without the connectors 110 of the present invention, the bar 112 positioning shown in FIG. 18 would have denied a practitioner access to the securing screws had the supporting unit been cast unitarily. Had the unit been cast singularly, the bar 112 would have had to be located too far lingually or too far labially, so as not to hamper access to the supporting screws, thereby discomforting the tongue or destroying esthetics and comfort.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. A denture support comprising:
a bar to span an edentulous space, the bar having a pair of opposed sidewalls, the sidewalls defining a longitudinal length and a height; and
a sleeve adapted to retain at least one pontic, and having a channel to embrace the bar, wherein a depth of the channel exceeds the height of the sidewalls.

2. The denture support of claim 1, wherein the bar and the sleeve are curvilinear.

3. The denture support of claim 2, wherein the curvilinear configuration of the bar and the sleeve are identical.

4. The denture support of claim 1, wherein the channel is U-shaped in transverse cross-section.

5. The denture support of claim 1, wherein a width of the channel is approximately equal to a thickness of the bar.

6. The denture support of claim 1, wherein at least one sidewall has a plurality of serrations extending longitudinally thereon.

7. The denture support of claim 6, wherein the channels frictionally embrace the plurality of serrations.

8. The denture support of claim 1, wherein the sleeve includes a bight and two spaced-apart legs, the legs each having an inner and an outer face, the inner and the outer faces each defining a longitudinal length and a height, wherein the inner faces embrace the sidewalls and the height of the inner faces exceeds the height of the sidewalls.

9. A denture support comprising:
a pair of spaced-apart bars that span an edentulous space, the bars each having a pair of opposed sidewalls, the sidewalls each defining a longitudinal length and a height; and
a sleeve adapted to retain one or more pontics and having a pair of channels adapted to embrace the bars, each channel having a tract separating two spaced-apart inner faces, the inner faces each defining a longitudinal length and a height, wherein the inner faces embrace the sidewalls and the height of the inner faces exceeds the height of the sidewalls.

10. The denture support of claim 9, wherein the bars and the sleeve are curvilinear.

11. The denture support of claim 10, wherein the curvilinear configuration of the bars and the sleeve are identical.

12. The denture support of claim 9, wherein each channel is U-shaped in transverse cross-section.

13. The denture support of claim 9, wherein the sleeve is W-shaped in transverse cross-section.

14. The denture support of claim 9, wherein a width of the channels is approximately equal to a thickness of the bars.

15. The denture support of claim 9, wherein at least one sidewall of each bar has a plurality of corrugations extending longitudinally thereon.

16. The denture support of claim 15, wherein the channels frictionally embrace the plurality of corrugations.

17. The denture support of claim 9, wherein each channel includes a tract separating two spaced-apart inner faces, the inner faces each defining a longitudinal length and a height, wherein the inner faces embrace the sidewalls and the height of the inner faces exceeds the height of the sidewalls.

18. A dental bridge comprising:
a bar spanning an edentulous space, at least one portion of the bar secured to a corresponding abutment, the bar having a pair of opposed sidewalls, the sidewalls defining a longitudinal length and a height; and
a sleeve adapted about its exterior to retain at least one pontic, and having a channel adapted to embrace the bar, wherein the channel has a depth exceeding the height of the sidewalls.

19. A dental bridge comprising:
a curvilinear bar spanning an edentulous space, each end of the bar secured to a corresponding abutment, the bar having a pair of opposed sidewalls, the sidewalls defining a longitudinal length and a height; and
a curvilinear sleeve adapted to embrace the bar and to retain at least one pontic, the sleeve being U-shaped in transverse cross-section, the sleeve having a bight and two spaced-apart legs, the legs each having an inner and an outer face, the inner and the outer faces each defining a longitudinal length and a height, wherein the inner faces embrace the sidewalls and the height of the inner faces exceeds the height of the sidewalls.

20. A dental bridge comprising:
a pair of spaced-apart bars spanning an edentulous space, at least one portion of each bar secured to a corresponding abutment, the bars each having a pair of opposed sidewalls, the sidewalls each defining a longitudinal length and a height; and
a sleeve adapted to retain one or more pontics and having a pair of channels adapted to embrace the bars, wherein a depth of each channel exceeds the height of the sidewalls.

21. A dental bridge comprising:
a pair of parallel, spaced-apart, curvilinear bars spanning an edentulous space, each end of the bars secured to a corresponding abutment, the bars each having a pair of opposed sidewalls, the sidewalls each defining a longitudinal length and a height; and
a curvilinear sleeve adapted to retain one or more pontics and having a pair of channels adapted to embrace the bars, each channel being U-shaped in transverse cross-section and having a tract separating two spaced-apart inner faces, the inner faces each defining a longitudinal length and a height, wherein the inner faces embrace the sidewalls and the height of the inner faces exceeds the height of the sidewalls.

22. A method of fabricating a dental restorative bridge or denture, comprising the steps of:
positioning a bar across an edentulous space spanning one or more abutments, and sizing the bar to fit;
releasably attaching one or more connectors to the bar;
re-positioning the bar across the edentulous space and affixing the connectors to respective copings of the abutments;
removing the bar from the one or more connectors;
investing and casting the copings and respectively affixed connectors; and
fixedly connecting the bar to the one or more connectors, wherein the bar accepts and retains a pontic portion of the bridge or denture.

23. The method of claim 22, wherein the one or more abutments are teeth.

24. The method of claim 22, wherein the one or more abutments are implants.

25. The method of claim 22, wherein the one or more connectors are U-shaped in transverse cross-section.

26. The method of claim 22, wherein the one or more connectors are attached to the bar with an open end of the one or more connectors allowing later removal of the bar.

27. The method of claim 22, wherein the one or more connectors are plastic prior to casting.

28. The method of claim 22, wherein the copings are plastic or wax prior to casting.

29. The method of claim 22, wherein the bar is fixedly connected to the one or more connectors in the mouth subsequent to fixation of the copings to the abutments.

30. The method of claim 29, wherein the copings are fixed to the abutments one at a time.

31. The method of claim 22, wherein the bar is fixedly connected to the one or more connectors by laser-welding in the laboratory.

32. The method of claim 22, further comprising the step of preparing the abutments for reception of the copings, wherein the prepared abutments are non-parallel.

33. A method of fabricating and placing a dental restorative bridge or denture, comprising the steps of:
positioning a bar between two abutment teeth at opposite ends of an edentulous space, and sizing the bar to fit;
releasably attaching a connector to each end of the bar, wherein the connectors each include an open side for removal of the bar;
re-positioning the bar across the edentulous space and affixing the connectors to respective copings of the abutment teeth;
removing the bar from the one or more connectors;
directing an investing and casting of the copings and the respectively affixed connectors;
fixedly connecting each cast coping, with respectively cast connector, to a respective abutment tooth, wherein the copings are fixed one at a time using a suitable dental cement; and
fixedly connecting one end of the bar to a respective connector using a suitable dental cement, wherein the bar accepts and retains a pontic portion of the bridge or denture.

34. The method of claim 33, further comprising the step of preparing the abutment teeth for reception of the copings, wherein the prepared abutment teeth are non-parallel.

35. A method of fabricating and placing a dental restorative bridge or denture, comprising the steps of:
positioning a bar about one or more abutment implants within an edentulous space, and sizing the bar to generally span the edentulous space;
releasably attaching a connector to the bar in a vicinity of each of the one or more abutment implants, wherein the connectors each include an open side for removal of the bar;
re-positioning the bar about the edentulous space and affixing the connectors to respective copings of the abutment implants;
removing the bar from the one or more connectors;
directing an investing and casting of the copings and the respectively affixed connectors;
fixedly connecting each cast coping, with respectively cast connector, to a respective abutment implant, wherein the copings are fixed one at a time using a suitable dental cement; and
fixedly connecting the bar to each respective connector using a suitable dental cement, wherein the bar accepts and retains a pontic portion of the bridge or denture.

36. The method of claim 35, further comprising a step of placing one or more abutment implants for reception of the copings, wherein the one or more abutment implants are non-parallel.

37. A dental prosthetic connector for attaching a bridge or denture to an abutment coping, the connector comprising two ends and four sides, wherein at least one end and one of the three sides are open, the three other sides being closed, the connector thereby enabling a receiving of and a releasable retaining of a bridge or denture supporting bar, rod, or post, the connector being flexible in a pre-casting method of fabricating a bridge or denture that enables a post-casting placement of the bridge or denture in the mouth wherein cast abutment copings are individually fixedly connected to respective abutments and the supporting bar, rod, or post is fixedly connected to the connectors, the bar, rod, or post then accepting and retaining a pontic portion of the bridge or denture.

38. A dental prosthetic connector for attaching a bridge or denture to an abutment coping, the connector being used in a method of fabricating and placing a dental restorative bridge or denture, wherein the method comprises the steps of:
positioning a bar between two abutment teeth at opposite ends of an edentulous space, and sizing the bar to fit;
releasably attaching a connector to each end of the bar, wherein the connectors each include an open side for removal of the bar;
re-positioning the bar across the edentulous space and affixing the connectors to respective copings of the abutment teeth;
removing the bar from the one or more connectors;
directing an investing and casting of the copings and the respectively affixed connectors;
fixedly connecting each cast coping, with respectively cast connector, to a respective abutment tooth, wherein the copings are fixed one at a time using a suitable dental cement; and
fixedly connecting one end of the bar to a respective connector using a suitable dental cement, wherein the bar accepts and retains a pontic portion of the bridge or denture.

39. The connector of claim 38, wherein the method using the connector further comprises the step of preparing the abutment teeth for reception of the copings, wherein the prepared abutment teeth are non-parallel.

40. A dental prosthetic connector for attaching a bridge or denture to an abutment coping, the connector being used in a method of fabricating and placing a dental restorative bridge or denture, wherein the method comprises the steps of:
positioning a bar about one or more abutment implants within an edentulous space, and sizing the bar to generally span the edentulous space;
releasably attaching a connector to the bar in a vicinity of each of the one or more abutment implants, wherein the connectors each include an open side for removal of the bar;
re-positioning the bar about the edentulous space and affixing the connectors to respective copings of the abutment implants;
removing the bar from the one or more connectors;
directing an investing and casting of the copings and the respectively affixed connectors;
fixedly connecting each cast coping, with respectively cast connector, to a respective abutment implant, wherein the copings are fixed one at a time using a suitable dental cement; and
fixedly connecting the bar to each respective connector using a suitable dental cement, wherein the bar accepts and retains a pontic portion of the bridge or denture.

41. The connector of claim 40, wherein the method using the connector further comprises a step of placing one or more abutment implants for reception of the copings, wherein the one or more abutment implants are non-parallel.
